(19) United States
(12) Patent Application Publication
(10) Pub. No.: US 2016/0111084 A1
(43) Pub. Date: Apr. 21, 2016

(54) SPEECH RECOGNITION DEVICE AND SPEECH RECOGNITION METHOD

(71) Applicant: Hyundai Motor Company, Seoul (KR)

(72) Inventors: Kyuseop Bang, Yongin (KR); Chang Heon Lee, Yongin (KR)

(21) Appl. No.: 14/810,554

(22) Filed: Jul. 28, 2015

(30) Foreign Application Priority Data
Oct. 17, 2014 (KR) 10-2014-0141167

(51) Int. Cl. G10L 15/02; G10L 15/08

(52) U.S. Cl. CPC G10L 15/02; G10L 15/08

(57) ABSTRACT

A speech recognition device includes: a collector collecting speech data of a first speaker from a speech-based device; a first storage accumulating the speech data of the first speaker; a learner learning the speech data of the first speaker accumulated in the first storage and generating an individual acoustic model of the first speaker based on the learned speech data; a second storage storing the individual acoustic model of the first speaker and a generic acoustic model; a feature vector extractor extracting a feature vector from the speech data of the first speaker when a speech recognition request is received from the first speaker; and a speech recognizer selecting either one of the individual acoustic model of the first speaker and the generic acoustic model based on an accumulated amount of the speech data of the first speaker and recognizing a speech command using the extracted feature vector and the selected acoustic model.

### CROSS-REFERENCE TO RELATED APPLICATION

This application claims priority to and the benefit of Korean Patent Application No. 10-2014-0141167 filed in the Korean Intellectual Property Office on Oct. 17, 2014, the entire contents of which are incorporated herein by reference.

### BACKGROUND OF THE DISCLOSURE

(a) Technical Field

The present disclosure relates to a speech recognition device and a speech recognition method.

(b) Description of the Related Art

According to conventional speech recognition methods, speech recognition is performed using an acoustic model which has been previously stored in a speech recognition device. The acoustic model is used to represent properties of speech of a speaker. For instance, a phoneme, a diphone, a triphone, a quinphone, a syllable, and a word are used as basic units for the acoustic model. Since the number of acoustic models decreases if the phoneme is used as the basic model of the acoustic model, a context-dependent acoustic model, such as the diphone, triphone, or the quinphone, is widely used in order to reflect a coarticulation phenomenon caused by changes between adjacent phonemes. A large amount of data is required to learn the context-dependent acoustic model.

Conventionally, voices of various speakers, which are recorded in an anechoic chamber or collected through servers, are stored as speech data, and the acoustic model is generated by learning the speech data. However, in such a method, it is difficult to collect a large amount of speech data and guarantee speech recognition performance since a tone of a speaker who actually uses a speech recognition function is often different from tones corresponding to the collected speech data. Thus, since the acoustic model is typically generated by learning speech data of adult males, it is difficult to recognize speech commands of adult females, seniors, or children who have voice tones that are different.

The above information disclosed in this Background section is only for enhancement of understanding of the background of the disclosure and therefore it may contain information that does not form the related art that is already known in this country to a person of ordinary skill in the art.

### SUMMARY OF THE DISCLOSURE

The present disclosure has been made in an effort to provide a speech recognition device and a speech recognition method having advantages of generating an individual acoustic model based on speech data of a speaker and performing speech recognition by using the individual acoustic model. Embodiments of the present disclosure may be used to achieve other objects that are not described in detail, in addition to the foregoing objects.

A speech recognition device according to embodiments of the present disclosure includes: a collector collecting speech data of a first speaker from a speech-based device; a first storage accumulating the speech data of the first speaker; a learner learning the speech data of the first speaker accumulated in the first storage and generating an individual acoustic model of the first speaker based on the learned speech data; a second storage storing the individual acoustic model of the first speaker and a generic acoustic model; a feature vector extractor extracting a feature vector from the speech data of the first speaker when a speech recognition request is received from the first speaker; and a speech recognizer selecting either one of the individual acoustic model of the first speaker and the generic acoustic model based on an accumulated amount of the speech data of the first speaker and recognizing a speech command using the extracted feature vector and the selected acoustic model.

The speech recognition device may further include a preprocessor detecting and removing a noise in the speech data of the first speaker.

The speech recognizer may select the individual acoustic model of the first speaker when the accumulated amount of the speech data of the first speaker is greater than or equal to a predetermined threshold value and select the generic acoustic model when the accumulated amount of the speech data of the first speaker is less than the predetermined threshold value.

The collector may collect speech data of a plurality of speakers including the first speaker, and the first storage may accumulate the speech data for each speaker of the plurality of speakers.

The learner may learn the speech data of the plurality of speakers and generate individual acoustic models for each speaker based on the learned speech data of the plurality of speakers.

The learner may learn the speech data of the plurality of speakers and update the generic acoustic model based on the learned speech data of the plurality of speakers.

The speech recognition device may further include a recognition result processor executing a function corresponding to the recognized speech command.

Furthermore, according to embodiments of the present disclosure, a speech recognition method includes: collecting speech data of a first speaker from a speech-based device; accumulating the speech data of the first speaker in a first storage; learning the accumulated speech data of the first speaker; generating an individual acoustic model of the first speaker based on the learned speech data; storing the individual acoustic model of the first speaker and a generic acoustic model in a second storage; extracting a feature vector from the speech data of the first speaker when a speech recognition request is received from the first speaker; selecting either one of the individual acoustic model of the first speaker and the generic acoustic model based on an accumulated amount of the speech data of the first speaker; and recognizing a speech command using the extracted feature vector and the selected acoustic model.

The speech recognition method may further include detecting and removing a noise in the speech data of the first speaker.

The speech recognition method may further include comparing an accumulated amount of the speech data of the first speaker to a predetermined threshold value; selecting the individual acoustic model of the first speaker when the accumulated amount of the speech data of the first speaker is greater than or equal to the predetermined threshold value; and selecting the generic acoustic model when the accumulated amount of the speech data of the first speaker is less than the predetermined threshold value.

The speech recognition method may further include collecting speech data of a plurality of speakers including the first speaker, and accumulating the speech data for each speaker of the plurality of speakers in the first storage.

The speech recognition method may further include learning the speech data of the plurality of speakers; and generating individual acoustic models for each speaker based on the learned speech data of the plurality of speakers.

The speech recognition method may further include learning the speech data of the plurality of speakers; and updating the generic acoustic model based on the learned speech data of the plurality of speakers.

The speech recognition method may further include executing a function corresponding to the recognized speech command.

Furthermore, according to embodiments of the present disclosure, a non-transitory computer readable medium containing program instructions for performing a speech recognition method includes: program instructions that collect speech data of a first speaker from a speech-based device; program instructions that accumulate the speech data of the first speaker in a first storage; program instructions that learn the accumulated speech data of the first speaker; program instructions that generate an individual acoustic model of the first speaker based on the learned speech data; program instructions that store the individual acoustic model of the first speaker and a generic acoustic model in a second storage; program instructions that extract a feature vector from the speech data of the first speaker if when a speech recognition request is received from the first speaker; program instructions that select either one of the individual acoustic model of the first speaker and the generic acoustic model based on an accumulated amount of the speech data of the first speaker; and program instructions that recognize a speech command using the extracted feature vector and the selected acoustic model.

Accordingly, speech recognition may be performed using the individual acoustic model of the speaker, thereby improving the speech recognition performance. In addition, collecting time and collecting costs of speech data required for generating the individual acoustic model may be reduced.

### BRIEF DESCRIPTION OF THE DRAWINGS

FIG. 1 is a block diagram of a speech recognition device according to embodiments of the present disclosure.

FIG. 2 is a block diagram of a speech recognizer and a second storage according to embodiments of the present disclosure.

FIG. 3 is a flowchart of a speech recognition method according to embodiments of the present disclosure.

<Description of symbols>

| | |
|---|---|
| 110: Vehicle infotainment device | 120: Telephone |
| 210: Collector | 220: Preprocessor |
| 230: First storage | 240: Learner |
| 250: Second storage | 260: Feature vector extractor |
| 270: Speech recognizer | 280: Recognition result processor |

### DETAILED DESCRIPTION OF THE EMBODIMENTS

The present disclosure will be described in detail hereinafter with reference to the accompanying drawings. As those skilled in the art would realize, the described embodiments may be modified in various different ways, all without departing from the spirit or scope of the present disclosure. Further, throughout the specification, like reference numerals refer to like elements.

Throughout this specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Throughout the specification, “speaker” means a user of a speech-based device such as a vehicle infotainment device or a telephone, and “speech data” means a voice of the user. Moreover, it is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one processor. The term “processor” may refer to a hardware device operating in conjunction with a memory. The memory is configured to store program instructions, and the processor is specifically programmed to execute the program instructions to perform one or more processes which are described further below. Moreover, it is understood that the below methods may be executed by an apparatus comprising the processor in conjunction with one or more other components, as would be appreciated by a person of ordinary skill in the art.

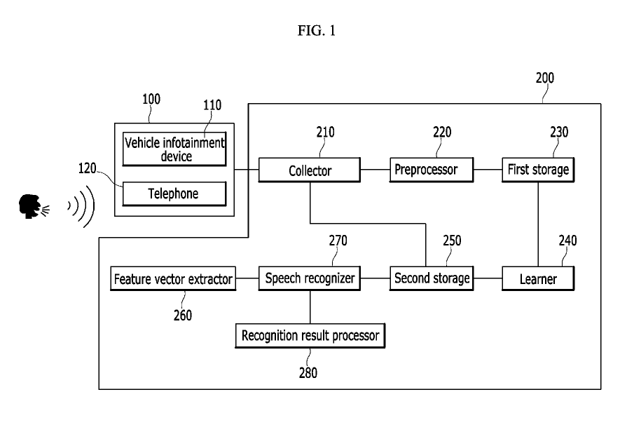

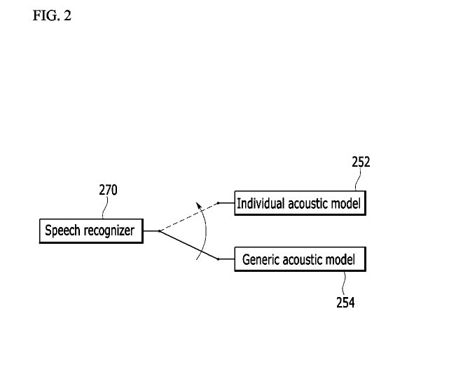

FIG. 1 is a block diagram of a speech recognition device according to embodiments of the present disclosure, and FIG. 2 is a block diagram of a speech recognizer and a second storage according to embodiments of the present disclosure.

As shown in FIG. 1, a speech recognition device 200 may be connected to a speech-based device 100 by wire or wirelessly. The speech-based device 110 may include a vehicle infotainment device 110 such as an audio-video-navigation (AVN) device and a telephone 120. The speech recognition device 200 may include a collector 210, a preprocessor 220, a first storage 230, a learner 240, a second storage 250, a feature vector extractor 260, a speech recognizer 270, and a recognition result processor 280.

The collector 210 may collect speech data of a first speaker (e.g., a driver of a vehicle) from the speech-based device 100. For example, if an account of the speech-based device 100 belongs to the first speaker, the collector 210 may collect speech data received from the speech-based device 100 as the speech data of the first speaker. In addition, the collector 210 may collect speech data of a plurality of speakers including the first speaker.

The preprocessor 220 may detect and remove a noise in the speech data of the first speaker collected by the collector 210.

The speech data of the first speaker in which the noise is removed is accumulated in the first storage 230. In addition, the first storage 230 may accumulate the speech data of the plurality of speakers for each speaker.

The learner 240 may learn the speech data of the first speaker accumulated in the first storage 230 to generate an individual acoustic model 252 of the first speaker. The generated individual acoustic model 252 is stored in the second storage 250. In addition, the learner 240 may generate individual acoustic models for each speaker by learning the speech data of the plurality of speakers accumulated in the first storage 230.

The second storage 250 previously stores a generic acoustic model 254. The generic acoustic model 254 may be previously generated by learning speech data of various speakers in an anechoic chamber. In addition, the learner 240 may update the generic acoustic model 254 by learning the speech data of the plurality of speakers accumulated in the first storage 230. The second storage 250 may further store context information and a language model that are used to perform the speech recognition.

If a speech recognition request is received from the first speaker, the feature vector extractor 260 extracts a feature vector from the speech data of the first speaker. The extracted feature vector is transmitted to the speech recognizer 270. The feature vector extractor 260 may extract the feature vector by using a Mel Frequency Cepstral Coefficient (MFCC) extraction method, a Linear Predictive Coding (LPC) extraction method, a high frequency domain emphasis extraction method, or a window function extraction method. Since the methods of extracting the feature vector are obvious to a person of ordinary skill in the art, detailed description thereof will be omitted.

The speech recognizer 270 performs the speech recognition based on the feature vector received from the feature vector extractor 260. The speech recognizer 270 may select either one of the individual acoustic model 252 of the first speaker and the generic acoustic model 254 based on an accumulated amount of the speech data of the first speaker. In particular, the speech recognizer 270 may compare the accumulated amount of the speech data of the first speaker with a predetermined threshold value. The predetermined threshold value may be set to a value which is determined by a person of ordinary skill in the art to determine whether sufficient speech data of the first speaker is accumulated in the first storage 230.

If the accumulated amount of the speech data of the first speaker is greater than or equal to the predetermined threshold value, the speech recognizer 270 selects the individual acoustic model 252 of the first speaker. The speech recognizer 270 recognizes a speech command by using the feature vector and the individual acoustic model 252 of the first speaker. In contrast, if the accumulated amount of the speech data of the first speaker is less than the predetermined threshold value, the speech recognizer 270 selects the generic acoustic model 254. The speech recognizer 270 recognizes the speech command by using the feature vector and the generic acoustic model 254.

The recognition result processor 280 receives a speech recognition result (i.e., the speech command) from the speech recognizer 270. The recognition result processor 280 may control the speech-based device 100 based on the speech recognition result. For example, the recognition result processor 280 may execute a function (e.g., a call function or a route guidance function) corresponding to the recognized speech command.

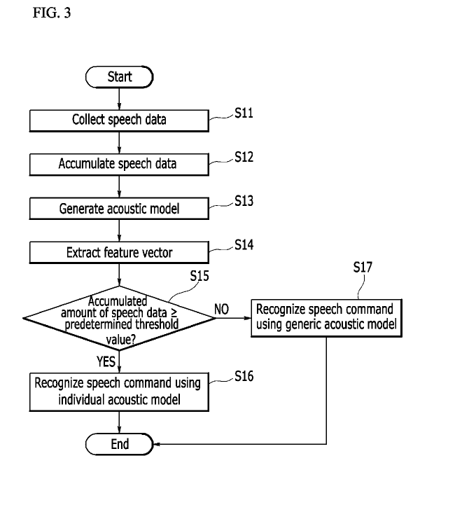

FIG. 3 is a flowchart of a speech recognition method according to embodiments of the present disclosure.

The collector 210 collects the speech data of the first speaker from the speech-based device 100 at step S11. The preprocessor 220 may detect and remove the noise of the speech data of the first speaker. In addition, the collector 210 may collect speech data of the plurality of speakers including the first speaker.

The speech data of the first speaker is accumulated in the first storage 230 at step S12. The speech data of the plurality of speakers may be accumulated in the first storage 230 for each speaker.

The learner 240 generates the individual acoustic model 252 of the first speaker by learning the speech data of the first speaker accumulated in the first storage 230 at step S13. In addition, the learner 240 may generate individual acoustic models for each speaker by learning the speech data of the plurality of speakers. Furthermore, the learner 240 may update the generic acoustic model 254 by learning the speech data of the plurality of speakers.

If the speech recognition request is received from the first speaker, the feature vector extractor 260 extracts the feature vector from the speech data of the first speaker at step S14.

The speech recognizer 270 compares the accumulated amount of the speech data of the first speaker with the predetermined threshold value at step S15.

If the accumulated amount of the speech data of the first speaker is greater than or equal to the predetermined threshold value at step S15, the speech recognizer 270 recognizes the speech command by using the feature vector and the individual acoustic model 252 of the first speaker at step S16.

If the accumulated amount of the speech data of the first speaker is less than the predetermined threshold value at step S15, the speech recognizer 270 recognizes the speech command by using the feature vector and the generic acoustic model 254 at step S17. After that, the recognition result processor 280 may execute a function corresponding to the speech command.

As described above, according to embodiments of the present disclosure, one of the individual acoustic model and the generic acoustic model may be selected based on the accumulated amount of the speech data of the speaker and the speech recognition may be performed by using the selected acoustic model. In addition, the customized acoustic model for the speaker may be generated based on the accumulated speech data, thereby improving speech recognition performance.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A speech recognition device comprising:
a collector collecting speech data of a first speaker from a speech-based device;
a first storage accumulating the speech data of the first speaker;
a learner learning the speech data of the first speaker accumulated in the first storage and generating an individual acoustic model of the first speaker based on the learned speech data;
a second storage storing the individual acoustic model of the first speaker and a generic acoustic model;
a feature vector extractor extracting a feature vector from the speech data of the first speaker when a speech recognition request is received from the first speaker; and
a speech recognizer selecting either one of the individual acoustic model of the first speaker and the generic acoustic model based on an accumulated amount of the speech data of the first speaker and recognizing a speech command using the extracted feature vector and the selected acoustic model.

2. The speech recognition device of claim 1, further comprising a preprocessor detecting and removing a noise in the speech data of the first speaker.

3. The speech recognition device of claim 1, wherein the speech recognizer selects the individual acoustic model of the first speaker when the accumulated amount of the speech data of the first speaker is greater than or equal to a predetermined threshold value and selects the generic acoustic model when the accumulated amount of the speech data of the first speaker is less than the predetermined threshold value.

4. The speech recognition device of claim 1, wherein
the collector collects speech data of a plurality of speakers including the first speaker, and
the first storage accumulates the speech data for each speaker of the plurality of speakers.

5. The speech recognition device of claim 4, wherein the learner learns the speech data of the plurality of speakers and generates individual acoustic models for each speaker based on the learned speech data of the plurality of speakers.

6. The speech recognition device of claim 4, wherein the learner learns the speech data of the plurality of speakers and updates the generic acoustic model based on the learned speech data of the plurality of speakers.

7. The speech recognition device of claim 1, further comprising a recognition result processor executing a function corresponding to the recognized speech command.

8. A speech recognition method comprising:
collecting speech data of a first speaker from a speech-based device;
accumulating the speech data of the first speaker in a first storage;
learning the accumulated speech data of the first speaker;
generating an individual acoustic model of the first speaker based on the learned speech data;
storing the individual acoustic model of the first speaker and a generic acoustic model in a second storage;
extracting a feature vector from the speech data of the first speaker when a speech recognition request is received from the first speaker;
selecting either one of the individual acoustic model of the first speaker and the generic acoustic model based on an accumulated amount of the speech data of the first speaker; and
recognizing a speech command using the extracted feature vector and the selected acoustic model.

9. The speech recognition method of claim 8, further comprising detecting and removing a noise in the speech data of the first speaker.

10. The speech recognition method of claim 8, further comprising:
comparing an accumulated amount of the speech data of the first speaker to a predetermined threshold value;
selecting the individual acoustic model of the first speaker when the accumulated amount of the speech data of the first speaker is greater than or equal to the predetermined threshold value; and
selecting the generic acoustic model when the accumulated amount of the speech data of the first speaker is less than the predetermined threshold value.

11. The speech recognition method of claim 8, further comprising:
collecting speech data of a plurality of speakers including the first speaker; and
accumulating the speech data for each speaker of the plurality of speakers in the first storage.

12. The speech recognition method of claim 11, further comprising:
learning the speech data of the plurality of speakers; and
generating individual acoustic models for each speaker based on the learned speech data of the plurality of speakers.

13. The speech recognition method of claim 11, further comprising:
learning the speech data of the plurality of speakers; and
updating the generic acoustic model based on the learned speech data of the plurality of speakers.

14. The speech recognition method of claim 8, further comprising executing a function corresponding to the recognized speech command.

15. A non-transitory computer readable medium containing program instructions for performing a speech recognition method, the computer readable medium comprising:
program instructions that collect speech data of a first speaker from a speech-based device;
program instructions that accumulate the speech data of the first speaker in a first storage;
program instructions that learn the accumulated speech data of the first speaker;
program instructions that generate an individual acoustic model of the first speaker based on the learned speech data;
program instructions that store the individual acoustic model of the first speaker and a generic acoustic model in a second storage;
program instructions that extract a feature vector from the speech data of the first speaker if when a speech recognition request is received from the first speaker;
program instructions that select either one of the individual acoustic model of the first speaker and the generic acoustic model based on an accumulated amount of the speech data of the first speaker; and
program instructions that recognize a speech command using the extracted feature vector and the selected acoustic model.
